(19) United States
(12) Patent Application Publication
(10) Pub. No.: US 2023/0343361 A1
(43) Pub. Date: Oct. 26, 2023

(54) DYNAMIC SIGNAL PROCESSING LOAD BASED ON SUBJECTIVE QUALITY ASSESSMENT

(71) Applicant: DSP Concepts, Inc., Santa Clara, CA (US)

(72) Inventors: Arpit Shah, Austin, TX (US); Paul Eric Beckmann, Sunnyvale, CA (US); Jeffrey M. Brockmole, Brighton, MI (US)

(21) Appl. No.: 18/137,543

(22) Filed: Apr. 21, 2023

Related U.S. Application Data
(60) Provisional application No. 63/333,667, filed on Apr. 22, 2022.

(51) Int. Cl. G10L 25/60; G10L 25/27

(52) U.S. Cl. CPC G10L 25/60; G10L 25/27

(57) ABSTRACT

A method of providing audio processing in an audio device, executed by one or more processors, comprises receiving an audio signal, performing a subjective quality assessment on the audio signal to generate a subjective quality assessment score, based on the subjective quality assessment score, providing control parameters to a signal processing module, and processing the audio signal, by the signal processing module, based on the control parameters. The subjective quality assessment may be a Mean Opinion Score (MOS) performed by a trained machine-learning model.

### RELATED APPLICATION DATA

This application claims the benefit of priority to U.S. Provisional Patent Application No. 63/333,667 filed on Apr. 22, 2022, the contents of which are incorporated herein by reference as if explicitly set forth.

### BACKGROUND

Existing methods for adjusting the type or amount of audio processing, such as noise reduction or active noise cancelling (ANC), typically depend on user activation (ANC on/off), the detection of the characteristics of a reference signal, such as a comparison between an input signal and a signal captured inside the earcup of ANC headphones, or other contextual information.

### BRIEF DESCRIPTION OF THE SEVERAL VIEWS OF THE DRAWINGS

Embodiments of the present disclosure are illustrated by way of example and not limitation in the figures of the accompanying drawings, in which like reference numbers indicate similar elements. To easily identify the discussion of any particular element or act, the most significant digit or digits in a reference number refer to the figure number in which that element is first introduced.

FIG. 1 illustrates example wireless ear buds that together form a set of wearable audio devices according to some examples.

FIG. 2 illustrates a system in which a server, a client device and a developer device are connected to a network according to some examples.

FIG. 3 illustrates an audio processing architecture according to some examples.

FIG. 4 illustrates a flowchart for providing audio processing according to some examples.

FIG. 5 illustrates an audio processing architecture according to some examples.

FIG. 6 illustrates a flowchart for providing audio processing according to some examples.

FIG. 7 illustrates an audio processing architecture according to some examples.

FIG. 8 illustrates the generation of machine learning models for use in generating a Mean Opinion Score, in accordance with some examples.

FIG. 9 illustrates a diagrammatic representation of a machine in the form of a computer system within which a set of instructions may be executed for causing the machine to perform any one or more of the methodologies discussed herein, according to an example.

### DETAILED DESCRIPTION

The amount and type of audio signal processing that is required to improve signal quality depends on a number of factors. Applying a certain type or level of signal processing when it is not required can needlessly consume system resources such as processing power or battery capacity. In some examples, the system disclosed herein used a subjective assessment of audio quality, such as a Mean Opinion Score (MOS), that is used as feedback into a control heuristic for scaling the audio processing load or capability. The MOS can be based on a machine learning model that has been trained on a set of known audio samples with known MOS scores that may have been determined through manual or other scoring techniques. The MOS value is conventionally on a numerical scale from 1 to 5, with one being “Impossible to Communicate” and 5 being “Perfect, like face-to-face.”

In some examples, provided is a method of providing audio processing in an audio device, executed by one or more processors, that includes receiving an audio signal, performing a subjective quality assessment on the audio signal to generate a subjective quality assessment score, based on the subjective quality assessment score, providing control parameters to a signal processing module, and processing the audio signal, by the signal processing module, based on the control parameters.

The subjective quality assessment may be performed by a machine learning model trained on training data includes audio samples and associated quality assessment scores, and the subjective quality assessment score that is generated by the subjective quality assessment may be a Mean Opinion Score.

Based on the control parameters, the signal processing module may alter its processing capability. Based on the control parameters, the signal processing module may alter a processor percentage dedicated to audio processing. A type of signal processing that is performed may depend on the subjective quality assessment score. A number of microphones used to generate the audio signal may also depend on a value of the subjective quality assessment score.

In some examples, performing the subjective quality assessment on the audio signal includes performing a first subjective quality assessment on an input audio signal, performing a second subjective quality assessment on an output audio signal, and based on a difference between the first and second subjective quality assessments, altering the control parameters provided to the signal processing module.

In some examples, the control parameters specify that no signal processing is to be performed when the subjective quality assessment score is above a first value, basic signal processing is to be performed when the subjective quality assessment score is between the first value and a second value that is lower than the first value, and more complex audio processing is to be performed when the subjective quality assessment score is a below the second value.

In some examples, provided is a non-transitory computer-readable storage medium, the computer-readable storage medium including instructions that when executed by a computer, cause the computer to perform operations for providing audio processing in an audio device according to any of the elements and limitations set forth above, the operations including but not limited to: receiving an audio signal, performing a subjective quality assessment on the audio signal to generate a subjective quality assessment score, based on the subjective quality assessment score, providing control parameters to a signal processing module, and processing the audio signal, by the signal processing module, based on the control parameters.

In some examples, provided is a computing apparatus includes a processor and a memory storing instructions that, when executed by the processor, configure the apparatus to perform operations for providing audio processing according to any of the elements and limitations set forth above, the operations including but not limited to: receiving an audio signal, performing a subjective quality assessment on the audio signal to generate a subjective quality assessment score, based on the subjective quality assessment score, providing control parameters to a signal processing module, and processing the audio signal, by the signal processing module, based on the control parameters.

Other technical features may be readily apparent to one skilled in the art from the following figures, descriptions, and claims.

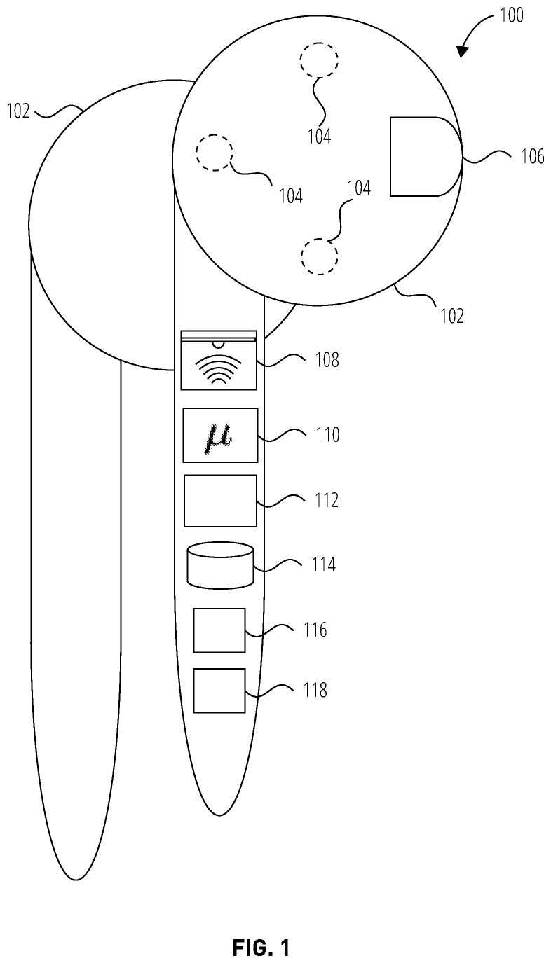

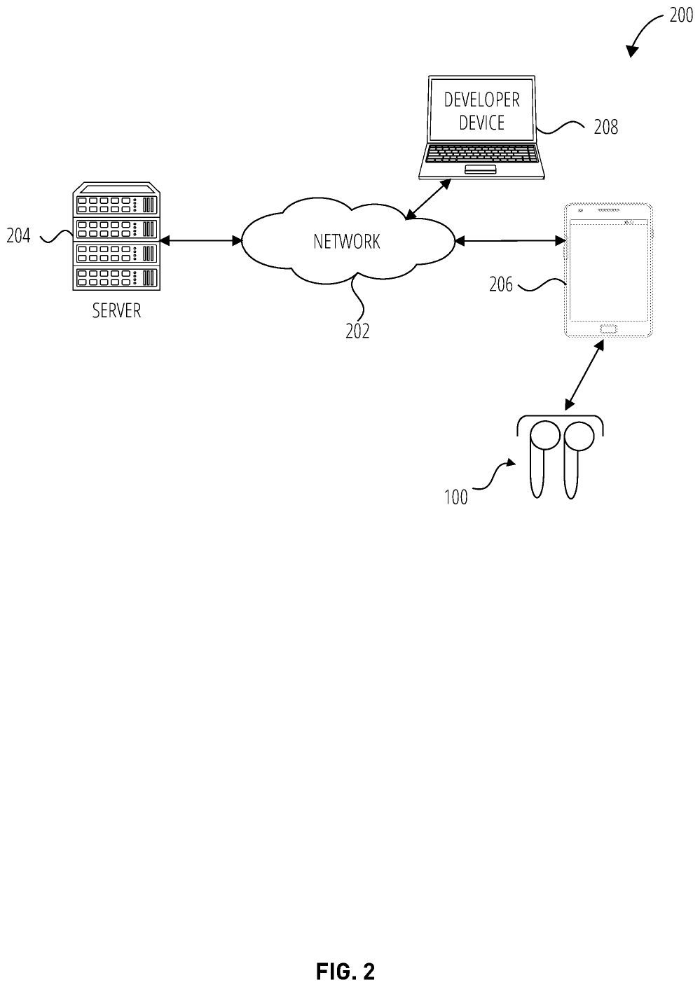

The methods disclosed herein may be implemented on any one of a number of different audio devices and systems as illustrated in FIG. 1 and FIG. 2 for example.

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

FIG. 1 illustrates example wireless ear buds 100 that together form a set of wearable audio devices. Each wireless ear bud 102 includes a communication interface 108 used to communicatively couple with an audio source or sink device, e.g., a client device 206 (see FIG. 2) that can provide audio data that the wireless ear buds 100 can reproduce as audio signals for a user of the wireless ear buds 100, or that can receive audio data from the wireless ear buds 100. Each wireless ear bud 102 also includes a battery 116 and optionally one or more sensors 104 for detecting a wearing status of the wireless ear buds 100, e.g., when a wireless ear bud 102 is placed in or on and/or removed from an ear.

Additionally, each wireless ear bud 102 includes an audio transducer 106 for converting a received signal including audio data, into audible sound and one or more microphones 118 for generating ambient and speech signals. A receive audio signal can be received from a paired companion communication device such as client device 206 via the communication interface 108, or alternatively the receive signal may be relayed from one wireless ear bud 102 to the other. A transmit audio signal can be generated from the one or more microphones 118 in the wireless ear buds 100.

One or both of the wireless ear buds 102 include a DSP framework 112 for processing received audio signals and/or signals from the one or more microphones 118, to provide to the audio transducer 106 or a remote user. The DSP framework 112 is a software stack running on a physical DSP core (not shown) or other appropriate computing hardware, such as a networked processing unit, accelerated processing unit, a microcontroller, graphics processing unit or other hardware acceleration. The DSP core will have additional software such as an operating system, drivers, services, and so forth. One or both of the wireless ear bud 102 also include a processor 110 and memory 114. The memory 114 in the wireless ear buds 100 stores firmware for operating the wireless ear buds 100 and for pairing the wireless ear buds 100 with companion communication devices.

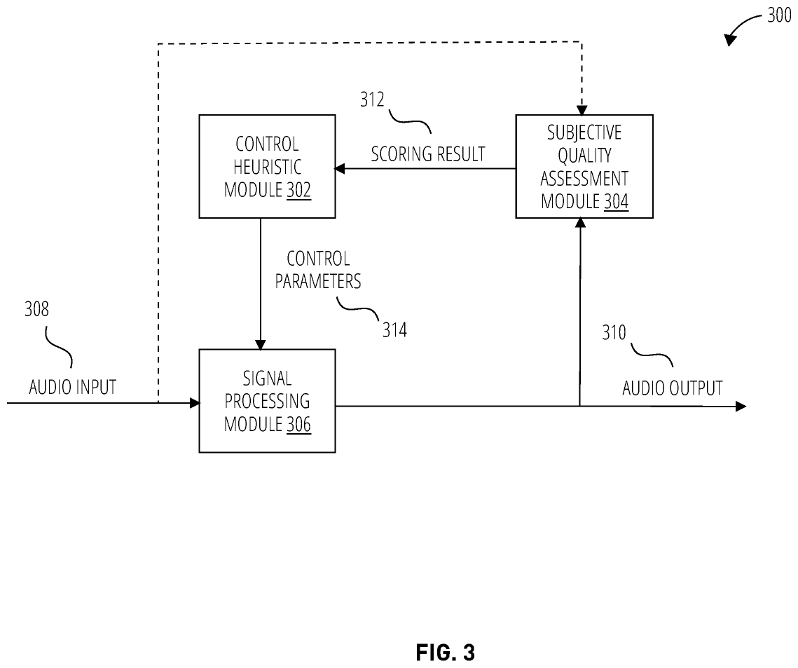

The DSP framework 112 includes interconnected audio processing modules and machine learning models arranged as described below with reference to FIG. 3 to FIG. 7, to perform the corresponding methods. The DSP framework 112 may for example operate on an audio input signal(s) received from one or more microphones 118, to generate an audio output signal that is transmitted to a client device 206 for transmission to a remote recipient and also to the audio transducer 106 of the wireless ear buds 100 as side tone. In another example, the audio input signal may be received from the client device 206 and be provided to the audio transducer 106 after being processed by the DSP framework 112.

Although described herein with reference to wireless ear buds, it will be appreciated that the methods and structures described herein are applicable to any audio device that may benefit therefrom.

FIG. 2 illustrates a system 200 in which a server 204, a client device 206 and a developer device 208 are connected to a network 202.

In various embodiments, the network 202 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like. In some embodiments, the network 202 may also include a voice network that conveys not only voice communications, but also non-voice data such as Short Message Service (“SMS”) messages, as well as data communicated via various cellular data communication protocols, and the like.

In various embodiments, the client device 206 may include desktop PCs, mobile phones, laptops, tablets, wearable computers, or other computing devices that are capable of connecting to the network 202 and communicating with the server 204, such as described herein. The client device 206 may be paired with wireless ear buds 100 (or other audio devices) that provide audio output to a user of the client device 206. Additionally, one or more developer devices 208 may be utilized to generate downloadable binary files that may be used to customize the audio of the wireless ear buds 100 as will be discussed in more detail below.

In various embodiments, additional infrastructure (e.g., short message service centers, cell sites, routers, gateways, firewalls, and the like), as well as additional devices may be present. Further, in some embodiments, the functions described as being provided by some or all of the server 204 and the client device 206 may be implemented via various combinations of physical and/or logical devices. However, it is not necessary to show such infrastructure and implementation details in FIG. 2 in order to describe an illustrative example.

FIG. 3 illustrates an audio processing architecture 300 according to some examples. The architecture includes a subjective quality assessment module 304, a control heuristic module 302 and a signal processing module 306.

The signal processing module 306 operates on an audio input signal 308 to generate an audio output signal 310. The audio input signal 308 and the audio output signal 310 are typically, but not necessarily, digital signals. The type and amount of signal processing performed on the audio input signal 308 to generate the audio output signal 310 is dependent on control parameters 314 passed from the control heuristic module 302. Depending on the signal processing that is specified by the control parameters 314, the signal processing module 306 may utilize other audio signals when performing the signal processing on the input audio signal, such as signals from one or more additional microphones or sensors, as well as other related data or contextual information.

Any signal processing that may improve or alter the audio input signal 308 may be used in signal processing module 306, including but not limited to noise reduction, echo cancellation, residual echo suppression and so forth, performed using digital signal processing techniques embodied in the DSP framework 112. From the perspective of the architecture 300, the MOS determination and feedback loop of the architecture do not depend on these signals as such.

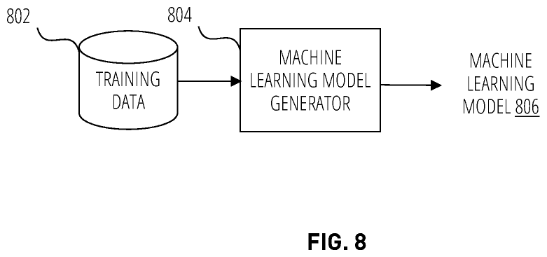

The subjective quality assessment module 304 operates on the audio output signal 310 to determine a MOS score 312 for the audio output signal 310 in real time. Alternatively, the subjective quality assessment module 304 may operate on the audio input signal 308 to determine a MOS score 312 for the audio input signal 308 in real time. The subjective quality assessment module 304 in some examples determines the MOS score 312 using a machine learning model 806, as described below with reference to FIG. 8. The score 312 is provided to the control heuristic module 302.

The control heuristic module 302 receives the MOS score 312 and, based on the value of the score, generates control parameters 314 for controlling the audio processing performed by the signal processing module 306. The control heuristic module 302 may for example be embodied as machine readable instructions for performing the control methods disclosed herein.

In use, as the audio quality of the audio output signal 310 decreases due to some environmental change, as determined by the MOS value from the subjective quality assessment module 304, the control heuristic module 302 modifies the signal processing performed by the signal processing module 306 load to overcome or address the environmental change. This could for example be done by an increase in processing capability (voltage, speed) at the expense of power consumption, or an increase in processor percentage dedicated to audio processing (such as increased echo cancellation capability.) Then, as the audio quality meets a predetermined level as determined from the MOS score 312 generated by the subjective quality assessment module 304, the audio processing performed by the signal processing module 306 can be modified accordingly, for example scaled back down, terminated, and so forth, by the control heuristic module 302, using the control parameters 314.

In addition to the MOS value changing based on an environmental change, the MOS value can change based on the audio input itself. For example, a hard rock song may be less susceptible to external noise due to frequency masking, and so forth, than classical music. The listening volume level could impact the MOS score as well.

In other examples, audio processing features can be enabled or disabled completely, such as no noise reduction being performed in in quiet environments or using a single microphone in a multi-microphone system in quiet environments, when the MOS score is high. One or more additional microphones can then be switched on as the environment becomes noisier as determined by the MOS.

Furthermore, features can be upgraded in increments or in the nature of the audio processing that is performed, based on variations in the MOS. In the case of silence or a high MOS score, no noise reduction is being performed. In an environment with a medium to high MOS, such as a car, basic stationary noise reduction may be performed. In the presence of nonstationary noise as indicated by a low to medium MOS score, machine learning noise reduction techniques may be employed.

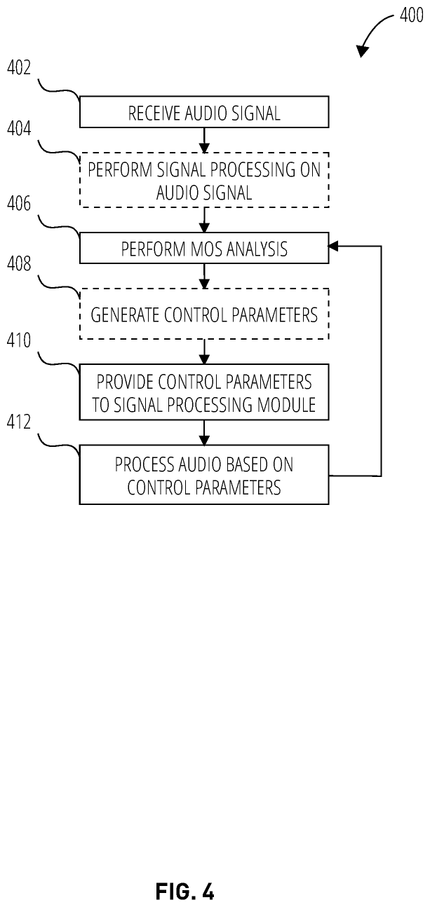

FIG. 4 illustrates a flowchart 400 for audio processing according to some examples. The flowchart 400 commences at operation 402 with receipt by the audio device (such as the wireless ear buds 102, the client device 206, a smart speaker or television, and so forth) of an audio input signal 308. The audio input signal 308 will typically be received from one or more microphones built into or associated with the device. In operation 404, signal processing is performed on the audio input signal 308. This may initially be a default level(s) or type(s) of audio processing.

In operation 406, a subjective quality assessment is performed on the audio output signal 310 by the subjective quality assessment module 304, after processing, to determine a MOS subjective quality assessment score 312. The score 312 is provided to the control heuristic module 302, which generates control parameters 314 for the audio processing based on the MOS score 312, in operation 408. In operation 410, the control heuristic module 302 then provides the control parameters 314 to the signal processing module 306, which processing the audio input signal 308 based on the control parameters 314 in operation 412. The method then returns to operation 406 where a new score 312 is determined based on the audio output signal 310 as after processing in operation 412, based on the control parameters 314. The method then continues from there with control parameters 314 being generated in operation 408 based on the updated MOS, and so forth.

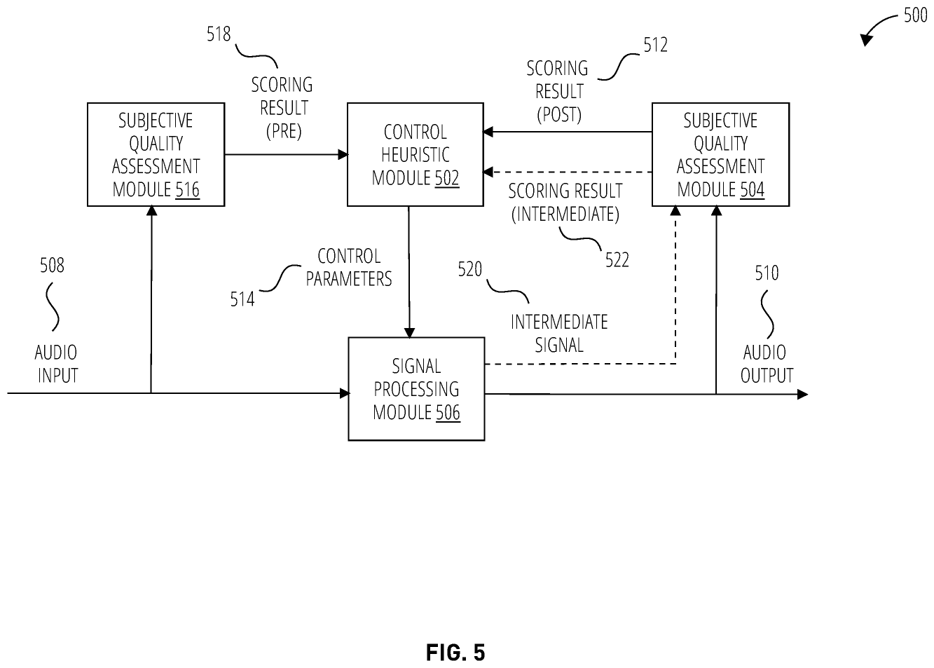

FIG. 5 illustrates an alternative audio processing architecture 500 according to some examples. As before, the architecture 500 includes a subjective quality assessment module 504, a control heuristic module 502 and a signal processing module 506. In this example, an audio input signal 508 is also assessed by a subjective quality assessment module 516 before it is processed by the signal processing module 506, that is, the subjective quality assessment module 516 operates “pre-processing.” This is in addition to the assessment of the audio output signal 510 by the subjective quality assessment module 504, after processing by the signal processing module 506. That is, the subjective quality assessment module 504 operates “post-processing.”

In the architecture 500, the subjective quality assessment module 516 operates on the audio input signal 508 to determine a MOS pre-processing score 518 for the audio input signal 508 in real time. The subjective quality assessment module 504 in some examples determines the MOS post-processing score 512 using a machine learning model 806, as described below with reference to FIG. 8. The pre-processing score 518 is provided to the control heuristic module 502, for use as described below.

The signal processing module 506 operates on the audio input signal 508 to generate an audio output signal 510. The type and amount of signal processing performed on the audio input signal 508 to generate the audio output signal 510 is dependent on control parameters 514 passed from the control heuristic module 502. Depending on the signal processing that is specified by the control parameters 514, the signal processing module 506 may utilize other audio signals when performing the signal processing on the input audio signal, such as signals from one or more additional microphones or sensors, as well as other related data or contextual information.

Any signal processing that may improve or alter the audio input signal 508 may be used in signal processing module 506, including but not limited to noise reduction, echo cancellation, residual echo suppression and so forth. From the perspective of the architecture 500, the MOS determination and feedback loop of the architecture do not depend on these signals as such.

The subjective quality assessment module 504 operates on the audio output signal 510 to determine a MOS post-processing score 512 for the audio output signal 510 in real time. The subjective quality assessment module 504 in some examples determines the MOS post-processing score 512 using a machine learning model 806, as described below with reference to FIG. 8. The post-processing score 512 is provided to the control heuristic module 502.

The control heuristic module 502 receives the MOS post-processing score 512 and the pre-processing score 518 and, based on the value of one of the scores, generates control parameters 514 for controlling the audio processing performed by the signal processing module 506. Additionally, the control heuristic module 502 determines the difference between the pre-processing score 518 and the post-processing score 512, which provides an empirical evaluation of the benefit of the processing. If the difference between the post-processing score 512 and the pre-processing score 518 is smaller than a certain threshold, the control heuristic module 502 can alter the control parameters 514 to apply different or more powerful audio processing. The threshold may be on a sliding scale, with a larger increase in MOS being required when the pre-processing score 518 is low and a smaller increase in MOS being required when the pre-processing score 518 is high. The difference between the two scores may in some examples be determined as a percentage.

In use, as the audio quality of the audio output signal 510 decreases due to some environmental change, as determined by MOS value(s) provided by the subjective quality assessment module 504 and/or the subjective quality assessment module 516, the control heuristic module 502 modifies the signal processing performed by the signal processing module 506 load to overcome or address the environmental change. This could for example be done by an increase in processing capability (voltage, speed) at the expense of power consumption, or an increase in processor percentage dedicated to audio processing (such as increased echo cancellation capability.) Then, as the audio quality meets a predetermined level as determined from the MOS post-processing score 512 or the pre-processing score 518, the audio processing performed by the signal processing module 506 can be scaled back down by the control heuristic module 502, using the control parameters 514.

In addition to the MOS value changing based on an environmental change, the MOS value can change based on the audio input itself. For example, a hard rock song may be less susceptible to external noise due to frequency masking, and so forth, than classical music. The listening volume level could impact it as well.

In other examples, audio processing features can be enabled or disabled completely based on a MOS value. For example, with no noise reduction being performed in in quiet environments, or using a single microphone in a multi-microphone system in quiet environments when the MOS value is high. One or more additional microphones can then be switched on as the environment becomes noisier as determined by the MOS value.

Furthermore, features can be upgraded in increments or in the nature of the audio processing that is performed, based on variations in the MOS value. In the case of silence or a high MOS value, no noise reduction is being performed. In an environment with a medium to high MOS value, such as in a car, basic stationary noise reduction may be performed. In the presence of nonstationary noise as indicated by a low to medium MOS value, machine learning noise reduction techniques may be employed.

In some examples, an intermediate signal 520 originating from a point along the signal processing performed by the signal processing module 506 may be provided to a subjective quality assessment module (such as subjective quality assessment module 504) for the determination of an intermediate scoring result 522, which can similarly be used by the control heuristic module 502 in its determination of the control parameters 514.

It will also be appreciated that the example architectures 500 could easily perform the functions of the architectures 300 as described above, by disabling the subjective quality assessment module 516 or ignoring the pre-processing score 518. The particular MOS values that are generated and used can depend on the circumstances at the time, for example with less MOS values being generated and used in the case of the pre-processing score 518 or post-processing score 512 having a high MOS value of, and more MOS values being determined from more different audio signals in the case the pre-processing score 518 or post-processing score 512 having a low MOS value. Also, while separate subjective quality assessment modules are shown in FIG. 5, a single subjective quality assessment module with multiple inputs and multiple outputs could be provided.

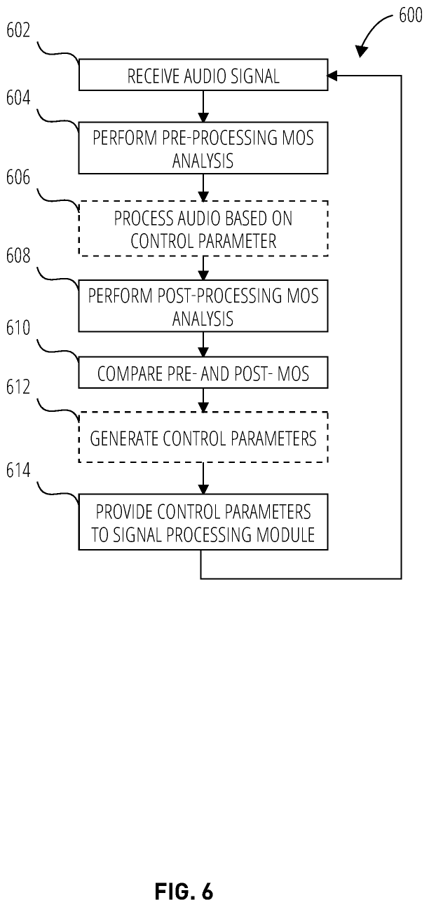

FIG. 6 illustrates a flowchart 600 for audio processing according to some examples. The flowchart 600 commences at operation 602 with receipt by the audio device (such as the wireless ear buds 102, the client device 206, a smart speaker or television, and so forth) of an audio input signal 508. The audio input signal 508 will typically be received from one or more microphones built into or associated with the device.

In operation 604, a subjective quality assessment is performed on the audio signal by the subjective quality assessment module 504, before processing, to determine a MOS pre-processing score 518, which is provided to the subjective quality assessment module 516. In operation 606, signal processing is performed on the audio input signal 508 by the signal processing module 506. This may initially be a default level(s) or type(s) of audio processing.

In operation 608, a subjective quality assessment is performed on the audio input signal 508 by the subjective quality assessment module 504, after processing, to determine a MOS post-processing score 512. The post-processing score 512 is provided to the control heuristic module 502. The control heuristic module 502 determines the difference between the pre-processing score 518 and the post-processing score 512 in operation 610, to assess the effectiveness of the audio processing that is being performed by the signal processing module 506. If the difference between the post-processing score 512 and the pre-processing score 518 is smaller than a certain threshold, the control heuristic module 502 can alter the control parameters 514 to apply different or more powerful audio processing.

In operation 612, the control heuristic module 502 generates control parameters 514 for the signal processing module 506 based on either the post-processing score 512 or the pre-processing score 518, as well as the difference between the two scores. In operation 614, the control heuristic module 502 then provides the control parameters 514 to the signal processing module 506. The method then returns to operation 602 where a new pre-processing score 518 is determined from the audio input signal 508, and the audio input signal 508 is processed by the signal processing module 506 based on the updated control parameters 514 in operation 606. The method then continues from there as before.

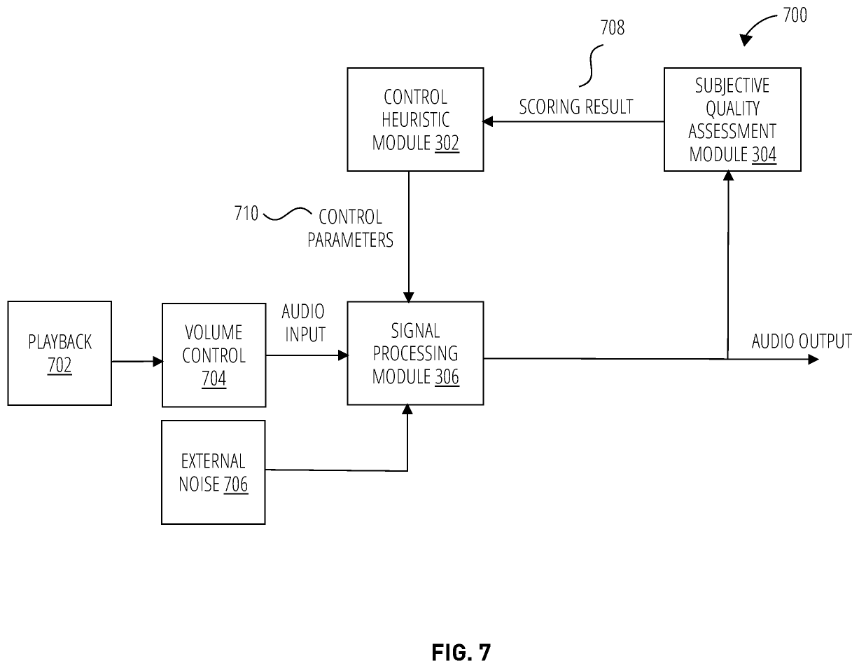

FIG. 7 illustrates an audio processing architecture 700 according to some examples. The architecture includes a subjective quality assessment module 304, a control heuristic module 302 and a signal processing module 306 as described above with reference to FIG. 3. FIG. 7 illustrates the effect that a change in volume level may have on the MOS score 708.

As shown, the architectures 700 includes audio playback 702 (for example, music, a video soundtrack and so forth) passing through a volume control 704. Also shown is external noise 706, which can affect the MOS score 708. As the user increases the volume level using the volume control 704, the need for signal processing such as ANC may reduce, since the signal to noise ratio increases with an increase in volume level. That is, the MOS score 708 may increase with an increase in volume level, resulting in the control heuristic module 302 providing control parameters 710 that reduce or alter the signal processing performed by the signal processing module 306 as described above.

FIG. 8 illustrates the generation of machine learning models for use in generating a Mean Opinion Score, in accordance with some examples.

As shown in FIG. 8, a machine learning model generator 804 receives MOS training data 802 as input. The training data 802 will, for example include different audio samples with each with their own corresponding MOS score. Based on the training data, the machine learning model generator 804 generates and trains a machine learning model 806 to generate a MOS value that represents the audio quality of an audio input signal.

The machine learning model generator 804 is configured to generate the machine learning model 806 using the training data 802 as input. For example, the machine learning model generator 804 is configured to train, test and/or otherwise tune the machine learning model 806 based on the audio signal data sets included in the training data 802. Examples of algorithms that may be employed by the machine learning model generator 804 for training and/or testing the machine learning model generator 804 include, but are not limited to, linear regression, boosted trees, multi-layer perceptron and/or random forest algorithms.

The completed machine learning model 806 is used in the subjective quality assessment module 304

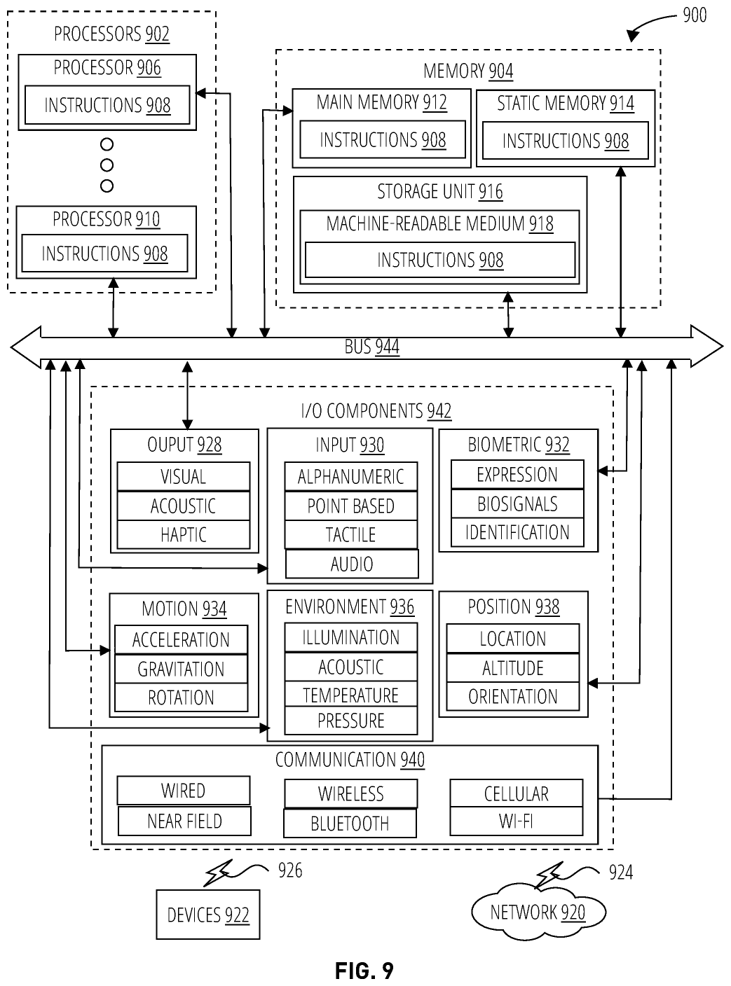

FIG. 9 illustrates a diagrammatic representation of a machine 900 in the form of a computer system within which a set of instructions may be executed for causing the machine to perform any one or more of the methodologies discussed herein, according to some examples. Specifically, FIG. 9 shows a diagrammatic representation of the machine 900 in the example form of a computer system, within which instructions 908 (e.g., software, a program, an application, an applet, an app, or other executable code) for causing the machine 900 to perform any one or more of the methodologies discussed herein may be executed. For example, the instructions 908 may cause the machine 900 to execute the methods described above. The instructions 908 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 908, sequentially or otherwise, that specify actions to be taken by the machine 900. Further, while only a single machine 900 is illustrated, the term “machine” shall also be taken to include a collection of machines 900 that individually or jointly execute the instructions 908 to perform any one or more of the methodologies discussed herein.

The machine 900 may include processors 902, memory 904, and I/O components 942, which may be configured to communicate with each other such as via a bus 944. In one example, the processors 902 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 906 and a processor 910 that may execute the instructions 908. The term “processor” is intended to include multi-core processors that may comprise two or more independent processors (sometimes referred to as “cores”) that may execute instructions contemporaneously. Although FIG. 9 shows multiple processors 902, the machine 900 may include a single processor with a single core, a single processor with multiple cores (e.g., a multi-core processor), multiple processors with a single core, multiple processors with multiples cores, or any combination thereof.

The memory 904 may include a main memory 912, a static memory 914, and a storage unit 916, both accessible to the processors 902 such as via the bus 944. The main memory 904, the static memory 914, and storage unit 916 store the instructions 908 embodying any one or more of the methodologies or functions described herein. The instructions 908 may also reside, completely or partially, within the main memory 912, within the static memory 914, within machine-readable medium 918 within the storage unit 916, within at least one of the processors 902 (e.g., within the processor's cache memory), or any suitable combination thereof, during execution thereof by the machine 900.

The I/O components 942 may include a wide variety of components to receive input, provide output, produce output, transmit information, exchange information, capture measurements, and so on. The specific I/O components 942 that are included in a particular machine will depend on the type of machine. For example, portable machines such as mobile phones will likely include a touch input device or other such input mechanisms, while a headless server machine will likely not include such a touch input device. It will be appreciated that the I/O components 942 may include many other components that are not shown in FIG. 9. The I/O components 942 are grouped according to functionality merely for simplifying the following discussion and the grouping is in no way limiting. In various examples, the I/O components 942 may include output components 928 and input components 930. The output components 928 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 930 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 942 may include biometric components 932, motion components 934, environmental components 936, or position components 938, among a wide array of other components. For example, the biometric components 932 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 934 may include acceleration sensor components (e.g., accelerometer), gravitation sensor components, rotation sensor components (e.g., gyroscope), and so forth. The environmental components 936 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 938 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 942 may include communication components 940 operable to couple the machine 900 to a network 920 or devices 922 via a coupling 924 and a coupling 926, respectively. For example, the communication components 940 may include a network interface component or another suitable device to interface with the network 920. In further examples, the communication components 940 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 922 may be another machine or any of a wide variety of peripheral devices (e.g., a peripheral device coupled via a USB).

Moreover, the communication components 940 may detect identifiers or include components operable to detect identifiers. For example, the communication components 940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 940, such as location via Internet Protocol (IP) geolocation, location via Wi-Fi® signal triangulation, location via detecting an NFC beacon signal that may indicate a particular location, and so forth.

The various memories (such as memory 904, main memory 912, static memory 914, and/or memory of the processors 902) and/or storage unit 916 may store one or more sets of instructions and data structures (e.g., software) embodying or utilized by any one or more of the methodologies or functions described herein. These instructions (e.g., the instructions 908), when executed by processors 902, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of non-transitory machine-readable media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 920 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 920 or a portion of the network 920 may include a wireless or cellular network, and the coupling 924 may be a Code Division Multiple Access (CDMA) connection, a Global System for Mobile communications (GSM) connection, or another type of cellular or wireless coupling. In this example, the coupling 924 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 908 may be transmitted or received over the network 920 using a transmission medium via a network interface device (e.g., a network interface component included in the communication components 940) and utilizing any one of a number of well-known transfer protocols (e.g., hypertext transfer protocol (HTTP)). Similarly, the instructions 908 may be transmitted or received using a transmission medium via the coupling 926 (e.g., a peer-to-peer coupling) to the devices 922. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 908 for execution by the machine 900, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

Changes and modifications may be made to the disclosed embodiments without departing from the scope of the present disclosure. These and other changes or modifications are intended to be included within the scope of the present disclosure, as expressed in the following claims.

1. A method of providing audio processing in an audio device, executed by one or more processors, comprising:
receiving an audio signal;
performing a subjective quality assessment on the audio signal to generate a subjective quality assessment score;
based on the subjective quality assessment score, providing control parameters to a signal processing module; and
processing the audio signal, by the signal processing module, based on the control parameters.

2. The method of claim 1, wherein the subjective quality assessment is performed by a machine learning model trained on training data comprising audio samples and associated quality assessment scores.

3. The method of claim 1, wherein the subjective quality assessment score generated by the subjective quality assessment is a Mean Opinion Score.

4. The method of claim 1, wherein, based on the control parameters, the signal processing module alters its processing capability.

5. The method of claim 1, wherein, based on the control parameters, the signal processing module alters a processor percentage dedicated to audio processing.

6. The method of claim 1, wherein performing the subjective quality assessment on the audio signal comprises:
performing a first subjective quality assessment on an input audio signal;
performing a second subjective quality assessment on an output audio signal; and
based on a difference between the first and second subjective quality assessments, altering the control parameters provided to the signal processing module.

7. The method of claim 1, wherein a type of signal processing that is performed depends on the subjective quality assessment score.

8. The method of claim 7, wherein the control parameters specify that no signal processing is to be performed when the subjective quality assessment score is above a first value, basic signal processing is to be performed when the subjective quality assessment score is between the first value and a second value that is lower than the first value, and more complex audio processing is to be performed when the subjective quality assessment score is a below the second value.

9. The method of claim 1 wherein a number of microphones used to generate the audio signal depends on a value of the subjective quality assessment score.

10. A non-transitory computer-readable storage medium, the computer-readable storage medium including instructions that when executed by a computer, cause the computer to perform operations for providing audio processing in an audio device, the operations comprising:
receiving an audio signal;
performing a subjective quality assessment on the audio signal to generate a subjective quality assessment score;
based on the subjective quality assessment score, providing control parameters to a signal processing module; and
processing the audio signal, by the signal processing module, based on the control parameters.

11. The non-transitory computer-readable storage medium of claim 10, wherein the subjective quality assessment is performed by a machine learning model trained on training data comprising audio samples and associated quality assessment scores.

12. The non-transitory computer-readable storage medium of claim 10, wherein the subjective quality assessment score generated by the subjective quality assessment is a Mean Opinion Score.

13. The non-transitory computer-readable storage medium of claim 10, wherein, based on the control parameters, the signal processing module alters a processor percentage dedicated to audio processing or a type of signal processing that is performed.

14. The non-transitory computer-readable storage medium of claim 10, wherein performing the subjective quality assessment on the audio signal comprises:
performing a first subjective quality assessment on an input audio signal;
performing a second subjective quality assessment on an output audio signal; and
based on a difference between the first and second subjective quality assessments, altering the control parameters provided to the signal processing module.

15. The non-transitory computer-readable storage medium of claim 10, wherein the control parameters specify that no signal processing is to be performed when the subjective quality assessment score is above a first value, basic signal processing is to be performed when the subjective quality assessment score is between the first value and a second value that is lower than the first value, and more complex audio processing is to be performed when the subjective quality assessment score is a below the second value.

16. A computing apparatus comprising:
a processor; and
a memory storing instructions that, when executed by the processor, configure the apparatus to perform operations for providing audio processing in an audio device, the operations comprising:
receiving an audio signal;
performing a subjective quality assessment on the audio signal to generate a subjective quality assessment score;
based on the subjective quality assessment score, providing control parameters to a signal processing module; and
processing the audio signal, by the signal processing module, based on the control parameters.

17. The computing apparatus of claim 16, wherein the subjective quality assessment is performed by a machine learning model trained on training data comprising audio samples and associated quality assessment scores.

18. The computing apparatus of claim 16, wherein performing the subjective quality assessment on the audio signal comprises:
performing a first subjective quality assessment on an input audio signal;
performing a second subjective quality assessment on an output audio signal; and
based on a difference between the first and second subjective quality assessments, altering the control parameters provided to the signal processing module.

19. The computing apparatus of claim 16, wherein the control parameters specify that no signal processing is to be performed when the subjective quality assessment score is above a first value, basic signal processing is to be performed when the subjective quality assessment score is between the first value and a second value that is lower than the first value, and more complex audio processing is to be performed when the subjective quality assessment score is a below the second value.

20. The computing apparatus of claim 16, wherein the subjective quality assessment score generated by the subjective quality assessment is a Mean Opinion Score.
